(19) United States
(12) Patent Application Publication
(10) Pub. No.: US 2003/0039605 A1
(43) Pub. Date: Feb. 27, 2003

(54) Process for the recovery of precious metals from fine carbon

(76) Inventor: Edward Ramsay, Haleybury (CA)

Correspondence Address: SPENCER, FANE, BRITT & BROWNE, 1000 WALNUT STREET, SUITE 1400, KANSAS CITY, MO, 64106-2140, US

(21) Appl. No.: 10/151,570

(22) Filed: May 20, 2002

(30) Foreign Application Priority Data
Aug. 21, 2001 (CA) 2,355,491

(51) Int. Cl. B01J 20/34

(52) U.S. Cl. 423/460; 423/461; 423/22

(57) ABSTRACT

The invention relates to a process for recovering precious metals from fine carbon bearing residual amounts of precious metals. The process involves the incineration of the carbon, followed by a method for separating the precious metals from carbon ash. Possible methods include cyanidation, gravity concentration, smelting, electrowinning and solvent extraction.

### FIELD OF THE INVENTION

This invention relates to a process for the recovery of gold and other precious metals from fine activated carbon.

### BACKGROUND OF THE INVENTION

Activated carbon is commonly used to extract precious metals, such as gold, from raw ore. Typically, cyanide is added to the ore, causing the precious metal separate from the ore and form a complex with cyanide ions. The precious metal cyanide is then adsorbed onto activated carbon.

The activated carbon is processed in order to remove the precious metal, often by treating it with hot caustic soda to remove the precious metals. This process removes much, but not all, of the precious metal. Typically 325-525 g of gold per tonne of grade remains on the activated carbon.

The activated carbon is then treated for reuse. It first undergoes an acid wash process in order to remove lime and calcium deposits. The carbon is then heated to remove organic compounds which could prevent the activated carbon from adsorbing precious metals. Finally, the activated carbon is quenched in water and passed over a sizing screen. Only large particles of carbon are reused; the finer particles are known as “spent carbon” or “fine carbon”. Fine carbon retains residual amounts of precious metals.

Residual precious metals are often recovered from fine carbon through a copper smelting process wherein fine carbon is mixed with copper concentrates. However, this process has several drawbacks. For one, the fine carbon must have less than 12% moisture content. Moreover, some fine carbon may be blown out of the smelting furnace, resulting in a loss of precious metals. The separation of precious metals from the copper anodes is also quite expensive.

### SUMMARY OF THE INVENTION

The present invention allows for efficient and cost effective recovery of precious metals from fine carbon.

The fine carbon is first gently heated to reduce the moisture content, and then cooled. Next, the fine carbon is incinerated in a furnace with a temperature preferably in the range of 600-800° C. such as, for example, a muffle furnace, a fluid bed roaster, a horizontal kiln, roasting vats or an open hearth roaster. Carbon combustion is an exothermic reaction, so additional heat is not required once the reaction begins.

Once all the carbon has combusted, the precious metals may be recovered from the residual ash. This may be accomplished in a number of ways. One such method is cyanidation (mixing the carbon ash with a cyanide, such as sodium cyanide), followed by processing through a carbon-in-pulp, carbon-in-leach, carbon-in-column or Merrill-Crowe circuit.

Carbon-in-pulp, carbon-in-leach and carbon-in-column are all carbon adsorption processes. The mixture of carbon ash, precious metal and cyanide is pumped through or flows through activated carbon, which results in the precious metal being adsorbed onto the activated carbon. Gold is then washed from the activated carbon with a solution of a cyanide such as sodium cyanide, and a strong alkali, such as sodium hydroxide or calcium hydroxide. The pregnant solution is subjected to electrolysis or zinc precipitation in order to recover the precious metal.

A Merrill-Crowe treatment involves first de-aerating the carbon ash, precious metal and cyanide mixture, followed by zinc precipitation to remove precious metal from the pregnant solution.

A second possibility is to smelt the ash in a bullion furnace with nitre (KNO₃), soda ash (Na₂CO₃), silica, and litharge (PbO), preferably at a temperature in the range of 1100° C. to 1300° C., and most preferably in the range of 1150° C. to 1250° C.

Another option is to subject the ash to gravity separation, such as by a table, jig or concentrator. The isolated gold would then be smelted.

A fourth option would be to strip the ashes with a solvent such as hot sodium hydroxide in order to dissolve the precious metals. The precious metal liquor is then sent to an electrowinning cell where the precious metals are plated on steel wool or stainless steel cathodes. The resulting product is mixed with nitre, soda ash, silica and litharge and melted in a bullion furnace, preferably at a temperature in the range of 1100° C. to 1300° C., and most preferably in the range of 1150° C. to 1250° C.

Finally, the ash may be dissolved in a solvent such as aqua regia, and the precious metals extracted using an ion exchange resin. The resin is stripped and the precious metals recovered by electrowinning as described above.

### BRIEF DESCRIPTION OF THE DRAWINGS

FIG. 1 is a flow chart depicting the process for recovery of precious metals from fine carbon.

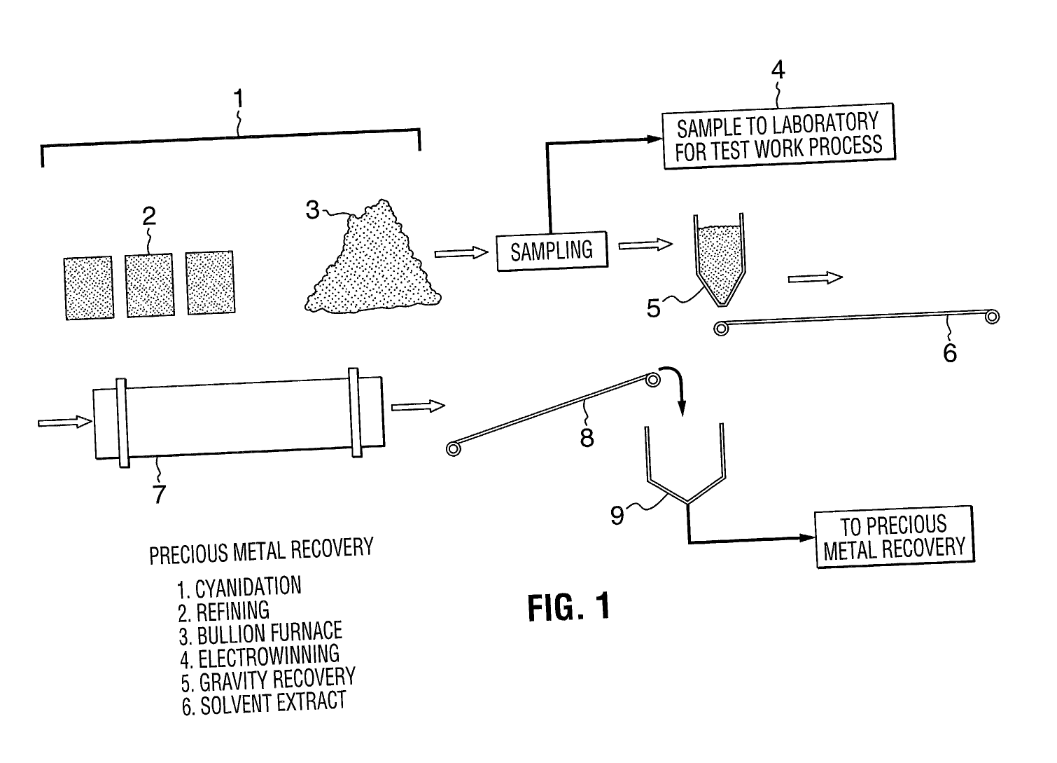

### DETAILED DESCRIPTION OF THE DRAWINGS

Fine or “spent” activated carbon (1) may be received as a bulk shipment (3) or in small lots (2). After samples (4) have been taken to ascertain moisture content and precious metal content, the remainder of the fine carbon is kept in a storage bin (5). From the storage bin the carbon is conveyed by a conveyer belt (6) to a furnace (7) for incineration. Once incineration is complete, the carbon ash and precious metals are conveyed via a second conveyer belt (8) to a quench tank (9). From there, the carbon ash may undergo cyanidation, smelting, gravity concentration, electrowinning or solvent extraction in order to isolate the precious metals.

### EXAMPLES

Incineration

A 209 g sample of fine carbon was assayed and found to contain 212.2 g/t of gold, and 1,046.8 g/t of silver.

The sample was heated and the fine carbon incinerated, resulting in a 32.1 g mixture of ash and precious metals. The sample was again assayed and found to contain 1,382.4 g/t of gold, and 6,813.6 g/t of silver, indicating that 100% of the precious metals were retained after incineration.

Cyanidation

A sample of incinerated fine carbon weighing 15.3 g was assayed and found to contain 1,382.4 g/t of gold, and 6,813.6 g/t of silver.

The sample was mixed with 1.23 kg/t of cyanide and 0.82 kg/t of lime (at a pH of 11.0) and mechanically agitated for 42 hours. The sample was then filtered with a buchner filter and the solid portion was washed with water to remove all traces of cyanide.

The dried solid was then assayed and found to contain 30.9 g/t of gold, and 3,403.9 g/t of silver. Gold recovery was therefore 97.8%, while silver recovery was 50.0%.

The embodiments of the invention in which an exclusive property or privilege is claimed are defined as follows:

1. A process for the recovery of precious metals which are adsorbed onto fine activated carbon, consisting of heating said fine activated carbon to a temperature of between 600° C. and 800° C., incinerating said fine activated carbon and cooling the resultant carbon ash.

2. A process as claimed in claim 1, wherein said carbon ash is subjected to cyanidation, said cyanidation being comprised of the following steps: mixing said carbon ash with cyanide and activated carbon to form a mixture; agitating said mixture to cause the precious metal to be adsorbed onto the activated carbon;
and extracting said precious metal from the activated carbon by processing through a carbon-in-pulp, carbon-in-leach, carbon-in-column or Merrill-Crowe circuit.

3. A process as claimed in claim 1, wherein said carbon ash is subjected to gravity concentration, said gravity concentration being comprised of agitating said carbon ash in a device such as a jig or concentrator.

4. A process as claimed in claim 1, wherein said carbon ash is smelted, said smelting being comprised of the following steps: mixing the carbon ash with nitre, soda ash, silica and litharge to create a furnace charge; heating said furnace charge in a bullion furnace to a temperature between 1100° C. and 1300° C.; and
pouring the molten precious metal into a mold.

5. A process as claimed in claim 1, wherein said carbon ash is subjected to electrowinning, said electrowinning being comprised of the following steps:
submersing said carbon ash in a solvent such as a strong alkali to form a pregnant liquor of dissolved precious metals; processing said pregnant liquor in an electrowinning cell to produce a sludge rich in precious metals; heating said sludge with a furnace charge of nitre, soda ash, silica and litharge to a temperature between 1100° C. and 1300° C.; and pouring the molten precious metal into a mold.

6. A process as claimed in claim 1, wherein said carbon ash is subjected to a solvent extraction, said solvent extraction being comprised of the following steps:
dissolving said carbon ash in a solvent such as aqua regia; extracting the precious metal from the solution using an ion exchange resin; stripping the precious metals from said ion exchange resin; processing said precious metals in an electrowinning cell to produce a sludge rich in precious metals; heating said sludge with a furnace charge of nitre, soda ash, silica and litharge to a temperature between 1100° C. and 1300° C.; and pouring the molten precious metal into a mold.
